(19) United States
(12) Patent Application Publication
(10) Pub. No.: US 2024/0391667 A1
(43) Pub. Date: Nov. 28, 2024

(54) METHOD FOR PRODUCING AN OPTICALLY MACHIINE-READABLE IDENTIFIER ON A PACKAGING FILM

(71) Applicant: ADAPA DIGITAL GESMBH, Wiener Neudorf (AT)

(72) Inventors: Stefan ZOISTER, Nußdorf am Attersee (AT); Stefan BIEL, Hamburg (DE); Jürgen KEPLINGER, Saxen (AT)

(73) Assignee: ADAPA DIGITAL GESMBH, Wiener Neudorf (AT)

(21) Appl. No.: 18/673,591

(22) Filed: May 24, 2024

(30) Foreign Application Priority Data
May 26, 2023 (AT) A 50419/2023

(51) Int. Cl. B65D 65/40; B32B 27/08; B32B 27/32; B32B 27/36; B41M 5/26; G06K 7/10; G06K 7/14

(52) U.S. Cl. CPC B65D 65/40; B32B 27/08; B32B 27/32; B32B 27/36; B41M 5/26; G06K 7/10722; G06K 7/1413; B32B 2255/10; B32B 2255/205; B32B 2307/4026; B32B 2307/41; B32B 2307/514; B32B 2553/00

(57) ABSTRACT

A method for producing an optically machine-readable identifier on a packaging film. The packaging film includes at least one first layer comprising photosensitive substances and at least one second layer arranged at least indirectly on the first layer, wherein, in order to produce the optically machine-readable identifier, a bundled light beam is directed in a specifiable manner onto the first layer, wherein the bundled light beam is at least partially absorbed by the first layer, wherein the bundled light beam brings about a color change in the first layer to produce the optically machine-readable identifier and is locally converted at least partially into thermal energy, wherein the thermal energy results in a local heat transfer to the second layer and causes a thermal reaction in the second layer, whereby an at least optically detectable image of the optically machine-readable identifier is additionally formed in the second layer.

### CROSS-REFERENCE TO RELATED APPLICATIONS

The present application claims priority to, and the benefit of, Austrian Patent Application No. A 50419/2023, filed May 26, 2023, entitled “METHOD FOR PRODUCING AN OPTICALLY MACHINE-READABLE IDENTIFIER ON A PACKAGING FILM”, which is incorporated by reference in its entirety.

### BACKGROUND OF THE INVENTION

### 1. Field of the Invention

The invention relates to a method for producing an optically machine-readable identifier on a packaging film.

### 2. Description of the Related Art

Product piracy is not only a major problem for pharmaceutical products, but also for everyday products such as foods, hygiene products, household care products, electronic devices, automotive parts, or leisure items. The authentication of these products is important and often not easy to accomplish, even with the integration of known security features used in banknotes or documents such as optically diffractive holograms, 2D color-shift printing, or animated features based on Fresnel lenses.

It is known that optically recognizable features such as Quick Response (QR) codes, Dot Matrix Codes (DMC), or DotCodes are easy to copy and counterfeit. To do this, these codes can be covered over on packaging or manipulated in some other way in order to pass off an older batch as a newer batch, for example.

It is also known to mechanically emboss or punch packaging films. However, this requires the mechanical devices to be altered accordingly for new identifiers after each batch or lot, which is time-consuming and cumbersome.

It is therefore the object of the invention to provide a method for producing an optically machine-readable identifier on a packaging film of the type mentioned at the outset with which the aforementioned drawbacks can be avoided and with which an optically machine-readable identifier can be produced easily and quickly on a packaging film, enabling manipulation to be clearly and reliably detected on the optically machine-readable identifier.

### SUMMARY OF THE INVENTION

The fact that the optically machine-readable identifier is produced by means of a bundled light beam—with a color change being brought about in the first layer and a thermal reaction in the second layer through a local heat transfer from the first layer to the second layer, whereby an at least optically detectable image of the optically machine-readable identifier is additionally formed in the second layer—provides the advantage that the optically machine-readable identifier can be produced easily and quickly on a packaging film, with the additional image in the second layer simultaneously creating an additional security feature. By comparing the optically machine-readable identifier with the image, the authenticity of a product can be ascertained easily and reliably.

The invention further relates to a packaging film with at least one optically machine-readable identifier.

It is therefore also the object of the invention to provide a packaging film with at least one optically machine-readable identifier of the type mentioned at the outset with which the aforementioned drawbacks can be avoided and with which the authenticity of a packaged product can be verified easily and reliably.

Since a color change has occurred in local regions on the first layer, rendering the optically machine-readable identifier optically detectable on the first layer and additionally forming an at least optically detectable image of the optically machine-readable identifier in the second layer, the optically machine-readable identifier of the first layer can be compared with the image of the optically machine-readable identifier of the second layer in order to verify its authenticity.

Packaging comprising a packaging film with an optically machine-readable identifier is also provided.

Furthermore, a computer-implemented method for verifying the optically machine-readable identifier on a packaging film is also provided.

The subclaims relate to additional advantageous embodiments of the invention.

### BRIEF DESCRIPTION OF THE DRAWINGS

The invention will be described in greater detail with reference to the accompanying drawings, in which only preferred embodiments are shown by way of example and in which:

FIG. 1 is an exemplary representation of a first preferred embodiment of a packaging film with an optically machine-readable identifier in a sectional view, and

FIG. 2 is an exemplary representation of a second preferred embodiment of a packaging film with an optically machine-readable identifier in a sectional view.

The thickness ratios of the layers shown in the figures do not necessarily correspond to the actual thickness ratios.

### DETAILED DESCRIPTION

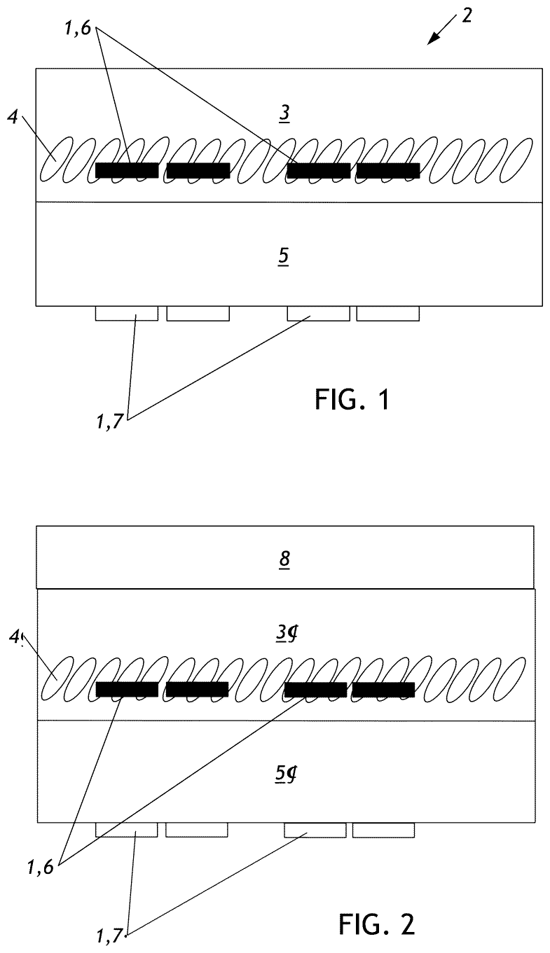

FIGS. 1 and 2 show at least portions of preferred embodiments of a packaging film 2 with at least one optically machine-readable identifier 1, the packaging film 2 comprising at least one first layer 3 comprising photosensitive substances 6 and at least one second layer 5 arranged at least indirectly on the at least one first layer 3, the optically machine-readable identifier 1 being formed in the at least one first layer 3 as a local color change 6, and an at least optically detectable image 7 of the optically machine-readable identifier 1 being formed in the at least one second layer 5.

Since a color change 6 has occurred in specifiable local regions on the first layer 3, rendering the optically machine-readable identifier 1 optically detectable on the first layer 3 and additionally forming an at least optically detectable image 7 of the optically machine-readable identifier 1 in the second layer 5, the optically machine-readable identifier 1 of the first layer 3 can be compared with the at least optically detectable image 7 of the optically machine-readable identifier 1 of the second layer 5 in order to verify its authenticity.

A method for producing an optically machine-readable identifier 1 on a packaging film 2 is also provided, wherein the packaging film 2 comprises at least one first layer 3 comprising photosensitive substances 4 and at least one second layer 5 arranged at least indirectly on the first layer 3, wherein, in order to produce the optically machine-readable identifier 1, a bundled light beam is directed in a specifiable manner onto the first layer 3, wherein the bundled light beam is at least partially absorbed by the first layer 3, wherein the bundled light beam brings about a color change 6 in the first layer 3 to produce the optically machine-readable identifier 1 and is locally converted at least partially into thermal energy, the thermal energy resulting in a local heat transfer to the second layer 5 and causing a thermal reaction in the second layer 5, whereby an at least optically detectable image 7 of the optically machine-readable identifier 1 is additionally formed in the second layer 5.

The fact that the optically machine-readable identifier 1 is produced by means of a bundled light beam—with a color change 6 being brought about in the first layer 3 and a thermal reaction in the second layer 5 through a local heat transfer from the first layer 3 to the second layer 5, whereby an at least optically detectable image 7 of the optically machine-readable identifier 1 is additionally formed in the second layer 5—provides the advantage that the optically machine-readable identifier 1 can be produced easily and quickly on a packaging film 2, with the additional image 7 in the second layer 5 simultaneously creating an additional security feature. By comparing the optically machine-readable identifier 1 with the image 7, the authenticity of a product can be determined easily and reliably.

The packaging film 2 comprises at least one optically machine-readable identifier 1. The packaging film 2 comprises at least one first layer 3, which comprises photosensitive substances 4, and at least one second layer 5, which is arranged at least indirectly on the at least one first layer 3. The optically machine-readable identifier 1 is formed in the at least one first layer 3 as a local color change 6, the at least optically detectable image 7 of the optically machine-readable identifier 1 being formed in the at least one second layer 5. A section of a first preferred embodiment of the packaging film 2 is shown by way of example in FIG. 1.

The optically machine-readable identifier 1 can preferably be a 2D code, in particular a Quick Response (QR) code, a Dot Matrix Code (DMC), or a DotCode, or a one-dimensional code such as a barcode. To produce the optically machine-readable identifier 1, a bundled light beam is directed in a specifiable manner onto the first layer 3, the bundled light beam being at least partially absorbed by the first layer 3, whereby a color change 6 is brought about in the first layer 3 locally in the region in which the bundled light beam is at least partially absorbed by the first layer 3.

Preferably, the bundled light beam can be moved in a grid pattern over a region of the packaging film 2 in order to produce the optically machine-readable identifier 1. The impingement of the bundled light beam on the packaging film can be controlled by means of a shutter or similar device.

The energy of the bundled light beam is converted locally in the first layer 3 at least partially into thermal energy, the thermal energy in the first layer 3 resulting in a local heat transfer to the second layer 5. The conversion of the energy of the bundled light beam into thermal energy takes place in those regions of the first layer 3 in which the bundled light beam is at least partially absorbed by the first layer 3. The thermal energy released or converted in the first layer 3 is transferred to the adjacent second layer 5, causing a thermal reaction in the second layer 5, whereby an at least optically detectable image 7 of the optically machine-readable identifier 1 is additionally formed in the second layer 5. The bundled light beam is used in two ways, namely to generate the color change 6 in the first layer 3 and for local heating.

The at least optically detectable image 7 in the second layer 5 is preferably an optically detectable change in the second layer 5 which results from the specific pattern of the machine-readable identifier 1 in the first layer 3. The specific pattern of the at least optically detectable image 7 does not necessarily have to be identical to the pattern of the machine-readable identifier 1. For example, an element of the machine-readable identifier 1, in particular a square or point corresponding to a bit, can be depicted in a distorted, in particular expanded, manner in the image 7. Neighboring elements of the machine-readable identifier 1 in the image 7 may also blend into one another. Such errors can arise, for example, due to undirected heat transfer as well as due to a special characteristic of the thermal reaction in the second layer 5. However, the extent of the distortion or expansion of the individual elements depends on the type of thermal reaction, the distance of the heat transfer, and the ratio of the layer thicknesses to one another. A provision is made, however, that the at least optically detectable image 7 bears a relationship with the optically machine-readable identifier 1. Complete blurring or distortion of the individual elements of the pattern is not intended. A distortion or an expansion of the individual elements therefore takes place within a tolerance range, so that the pattern of the at least optically detectable image 7 can still be brought into a clear correlation with the pattern of the optically machine-readable identifier 1 despite expansions or distortions.

A provision can be preferably made that the machine-readable identifier 1 is directly derivable from the image 7. The pattern of the machine-readable identifier 1, and thus also the information thereof, can thus be derived directly from the pattern of the image 7. The relationship between the machine-readable identifier 1 and the image 7 can therefore be bijective. In particular, the distortion when creating the image 7 can be so small that every element of the machine-readable identifier 1 in the image 7 can be clearly and directly identified. This offers the advantage that the readable information can be compared directly in order to reconcile the machine-readable identifier 1 with the image 7.

Preferably, the optically machine-readable identifier 1 in the first layer 3 can be detected optically from the outside, whereas the image 7 of the optically machine-readable identifier 1 in the second layer 5 can be detected optically from the inside. The image 7 in the second layer 5 is then a mirror image of the optically machine-readable identifier 1 in the first layer 3.

The optically machine-readable identifier 1 includes the color change 6 in the first layer 3. The color change 6 can be from white to black or from transparent to white, for example.

The second layer 5 can preferably comprise at least one thermoplastic material or consist of at least one thermoplastic material. Polyolefins such as polyethylene (PE), polypropylene (PP), but also acrylonitrile butadiene styrene (ABS), polyamides (PA), polylactide (PLA), polymethyl methacrylate (PMMA), polycarbonate (PC), polyethylene terephthalate (PET), polystyrene (PS), polyether ether ketone (PEEK), or polyvinyl chloride (PVC) can be preferably used as thermoplastics.

A provision can be preferably made that the thermal reaction in the second layer 5 brings about a local change in the thickness of the second layer 5.

The at least optically detectable image 7 can be embodied as a color change or as a local alteration in color and/or as an elevation. If the optically detectable image 7 is embodied as an elevation, it protrudes from the surface of the second layer 5. For this purpose, the volume of the second layer 5 is irreversibly increased locally in the vicinity of the elevation.

The elevations form a structure on the surface of the second layer 5 which can also be perceived haptically and which is an image 7 of the optically machine-readable identifier 1.

When used as packaging, the packaging film 2 has an outer and an inner layer, with the outer layer forming the outer side and the inner layer forming the inner side of the packaging. The inner layer or inner side faces toward the packaged product, and the outer layer or outer side faces away from the product.

A provision can be preferably made that a layer following the first layer 3 in the layered structure of the packaging film 2 is opaque, in which case the first layer 3 preferably forms the outer layer of the packaging. The second layer 5 can form the inner side of the packaging, or at least one additional layer can be arranged on the second layer 5.

Especially preferably, a provision can be made that, in a region of the packaging film 2 between the first layer 3 and an inner side of the packaging film 2, at least one layer, particularly the second layer 5, is opaque. The second layer 5 is arranged between the first layer 3 and the inner side. The second layer 5 can, in particular, be arranged adjacent to the inner side of the packaging film 2.

A layered structure can be provided, in which case the first layer 3 forms the outer side of the packaging film, the second layer 5 is arranged downstream from the first layer 3, and an additional layer is arranged downstream from the second layer 5, forming the inner side of the packaging.

Alternatively, a provision can be made that the second layer 5 forms the inner side of the packaging.

The term “opaque” is referring to the human eye.

An image 7 of the optically machine-readable identifier 1 can still be identified even without a color change that is visible on or through the second layer 5. This is important particularly if a layer subsequent to the first layer 3—e.g., the second layer 5—is opaque. When a package is sealed, an opaque layer subsequent to the first layer 3 does not allow any indication to be given as to what the image 7 of the optically machine-readable identifier 1 looks like on the second layer 5—i.e., on the inner side of the packaging—thereby enhancing security against counterfeiting.

The opaque layer can be preferably arranged between the first layer 3 and the second layer 5. This means that the second layer 5 with the image 7 is directly visible from the inside. The opaque layer can, in particular, be a metallization.

Depending on the requirements of the pharmaceutical or food industry, some packaging for certain products must be opaque, as these can react with sunlight in particular.

A provision can also be especially preferably made that the first layer 3 is arranged between the second layer 5 and a third layer 8, in which case the bundled light beam first penetrates the third layer 8 before it strikes the first layer 3. The third layer 8 can be a protective layer which protects the first layer 3 and/or the second layer 5 from external influences. In the case of packaging, the third layer 8 can preferably form the outer side of the packaging or at least adjoin the outer side of the packaging. The third layer 8 does not have to absorb the bundled light beam or otherwise interact with the light beam, since in the present invention it is the color change in the first layer 3 and the generation of at least an optically detectable image 7 of the optically machine-readable identifier 1 in the second layer 5 that are important. A section of a second preferred embodiment of a packaging film 2 with three layers 3, 5, 8 is shown by way of example in FIG. 2.

A provision can be preferably made that a laser, in particular a CO₂ laser, is used to generate the bundled light beam. The optically machine-readable identifier 1 can be generated easily, quickly, and accurately using a laser. If the optically machine-readable identifier 1 changes after a batch, this only requires an easy-to-implement change in a software in order to enable the laser to generate the new optically machine-readable identifier 1 on the packaging film 2. The wavelength range of the laser does not have to be in the visible range, but rather can also be in the ultraviolet range or the infrared range.

A provision can be made that, in the case of use as a packaging film 2, and hence as packaging, the second layer 5 functions as a barrier layer which prevents oxygen and moisture from penetrating into the packaging.

A provision can be made that a fourth layer is arranged on the second layer 5, which represents a barrier layer and preferably comprises ethylene-vinyl alcohol copolymer (EVOH) or consists of EVOH. Alternatively, a metallization arranged on the second layer 5 is particularly suitable for this purpose. A metallization is a very thin coating with a metal which preferably has a thickness in the sub-μm range. For example, the metallization can have a thickness of 50 nm to 300 nm.

The packaging can preferably be packaging for food, medical products, pharmaceutical products, or other consumer goods. The packaging can be a tear-open package, for example.

Depending on the application and hygiene regulations, the packaging can also have a chemical coating.

A provision can be preferably made that the photosensitive substances 6 comprise pigments, in particular mica-based pigments. Photosensitive substances 6 are substances having at least one property which changes on contact with light. In this case, the photosensitive substances react when the bundled light beam strikes them, bringing about a color change.

The first layer 3 can be referred to as a photosensitive or laser-sensitive layer.

A provision can be especially preferably made that the first layer 3 is only present in that region in which the optically machine-readable identifier 1 is arranged. This can save costs. Furthermore, this prevents any attempt at manipulation by placing a second and counterfeit identifier on another part of the packaging, for example.

To achieve this, the at least one first layer 3 can be preferably printed on the at least one second layer 5.

The following are practical examples of the layered structure of packaging film 2:

Preferably, the packaging film can have a 20 μm-thick layer of oriented or stretched polypropylene (OPP) adjacent to a laser-sensitive layer, which represents the first layer 3, with an adhesive layer that is thin compared to the other plastic layers being arranged on the laser-sensitive layer, a 20 μm-thick layer of oriented or stretched polypropylene (OPP) being arranged on the adhesive layer, an aluminum metallization being arranged on the side of the layer of oriented polypropylene facing away from the adhesive layer, and a 30 μm-thick layer of an unstretched polypropylene (CPP) being arranged on the metallization. In principle, the second layer of OPP and the layer of CPP represent second layers 5.

Furthermore, a provision can be made that a laser-sensitive layer, which represents the first layer 3, is arranged on a 25 μm-thick layer of polyethylene, produced according to the MDO process (Machine Direction Orientation, MDO-PE), an adhesive layer which is thin compared to the other plastic layers is arranged on the laser-sensitive layer, and a 55 μm-thick layer of polyethylene is arranged on the adhesive layer, which corresponds to the at least one second layer 5.

A provision can also be made that the packaging film has a 20 μm-thick layer of oriented or stretched polypropylene (OPP), in which case a thin adhesive layer is arranged on this layer, a laser-sensitive layer, which represents the first layer 3, is arranged on the adhesive layer, a 12 μm-thick polyethylene terephthalate layer (PET) is arranged on the laser-sensitive layer, and a 30 μm-thick layer of an unstretched polypropylene (CPP) is arranged on the polyethylene terephthalate layer. Here, the polyethylene terephthalate layer and the layer of unstretched polypropylene represent the second layer 5.

A computer-implemented method for verifying the optically machine-readable identifier 1 on a packaging film 2 is also provided, wherein, in a first step, the optically machine-readable identifier 1 on the first layer 3 is optically read in by means of a camera, wherein, in a subsequent step, a verification program installed on a client and interacting with the camera prompts the user to optically read in the optically detectable image 7 on the second layer 5, wherein, after the reading-in of the optically detectable image 7 on the second layer 5, the verification program compares the optically machine-readable identifier 1 of the first layer 3 with the optically detectable image 7 of the second layer 5 and outputs a signal relating to a match.

The camera used can preferably be a smartphone camera which scans in the optically machine-readable identifier 1 in a first step. In the case of a smartphone as a client, a verification program installed on the smartphone and interacting with the camera prompts the user to optically read in, i.e., scan in, the optically machine-readable identifier 1 on the second layer 5. In the case of a fully packaged product, if there is an opaque layer subsequent to the first layer 3, the packaging must be opened in order to optically read or scan in the image of the optically machine-readable identifier 1 on the second layer 5.

The verification program compares the optically machine-readable identifier 1 of the first layer 3 with the image 7 of the optically machine-readable identifier 1 of the second layer 5 and outputs a signal relating to a match.

This makes it possible to reliably verify, in the case of packaging that cannot be opened non-destructively, particularly in the case of packaging that is also not transparent, whether the optically machine-readable identifier 1 of the first layer 3 has been altered, thereby achieving a high level of security, since the encoding takes place within the layers 3, 5. It is therefore not possible to manipulate the codes without destroying the layers 3, 5.

Preferably, the verification program can infer the optically machine-readable identifier 1 from the at least optically detectable image 7 and take into account any distortions in the at least optically detectable image 7. This means that, even if the at least optically detectable image 7 is slightly blurred or distorted, the verification program can infer the optically machine-readable identifier 1 and check whether the at least optically detectable image 7 matches the optically machine-readable identifier 1 or bears a relationship therewith.

A provision can also be preferably made that each optically machine-readable identifier 1 is assigned a specific UUID on a server and validated, in which case the verification program establishes contact with the server in order to compare for a match and checks whether a specific UUID exists for the optically machine-readable identifier 1 and, each time a data packet is read, the data is first verified via APIs by calculating a crypto hash and comparing it with a stored hash of a packet in an assigned blockchain.

A UUID (Universally Unique IDentifier) is a 128-bit number used to identify information in computer systems and is extremely difficult to manipulate or duplicate.

Each individual optically machine-readable identifier 1 is preferably linked directly to a specific UUID (12 alphanumeric digits according to GS1) and authenticated on a platform via connected machines. The UUIDs are read in and validated by readers and then sent to an FTP server. As soon as a batch is finished, it is processed and registered by appropriate software.

The security and integrity of the data is ensured by using crypto hashes as evidence and by storing the data in a backend based on blockchain technology. The actors involved within the supply chain use their public-private keys, which are stored in a secure wallet, to sign the added information and gain access to the existing data of the individual packets.

Each time a packet is read, the data is first verified via application programming interfaces (APIs) by calculating a crypto hash and comparing it with the stored hash of a packet in the blockchain. This greatly increases the security of products against counterfeiting and ensures the security and integrity of data in a decentralized manner.

The following are principles for understanding and interpreting the present disclosure.

Features are usually introduced with an indefinite article “a, an.” Unless the context indicates otherwise, “a, an” should not be understood as constituting a numeral.

For value ranges, the end points are included insofar as not otherwise indicated by the context.

The invention claimed is:

1-10. (canceled)

11. A method for producing an optically machine-readable identifier on a packaging film, the packaging film comprising at least one first layer comprising photosensitive substances and at least one second layer arranged at least indirectly on the first layer, the method comprising:
directing a bundled light beam in a specifiable manner onto the first layer in order to produce the optically machine-readable identifier, the bundled light beam being at least partially absorbed by the first layer;
wherein the bundled light beam brings about a color change in the first layer to produce the optically machine-readable identifier and is locally converted at least partially into thermal energy, the thermal energy resulting in a local heat transfer to the second layer and causing a thermal reaction in the second layer; and
wherein an at least optically detectable image of the optically machine-readable identifier is additionally formed in the second layer.

12. The method according to claim 11, wherein the thermal reaction in the second layer brings about a local change in a thickness of the second layer.

13. The method according to claim 11, wherein the first layer is arranged between the second layer and a third layer, the bundled light beam first penetrating the third layer before it strikes the first layer.

14. A packaging film with at least one optically machine-readable identifier, comprising:
at least one first layer comprising photosensitive substances; and
at least one second layer arranged at least indirectly on the at least one first layer;
wherein the optically machine-readable identifier is formed in the at least one first layer as a local color change; and
wherein an at least optically detectable image of the optically machine-readable identifier is formed in the at least one second layer.

15. The packaging film according to claim 14, wherein, in a region of the packaging film between the first layer and an inner side of the packaging film, at least one layer, particularly the second layer, is opaque.

16. The packaging film according to claim 14, wherein the photosensitive substances comprise pigments, in particular mica-based pigments.

17. The packaging film according to claim 14, wherein the at least one first layer is only present in that region in which the optically machine-readable identifier is arranged.

18. Packaging, comprising a packaging film according to claim 14.

19. A computer-implemented method for verifying the optically machine-readable identifier on a packaging film according to claim 14, the method when executed comprising:
in a first step, the optically machine-readable identifier on the first layer is optically read in by means of a camera;
in a subsequent step, a verification program installed on a client and interacting with the camera prompts the user to optically read in the at least optically detectable image on the second layer; and
after the reading-in of the optically machine-readable identifier on the second layer, the verification program compares the optically machine-readable identifier of the first layer with the at least optically detectable image of the second layer and outputs a signal relating to a match.

20. The computer-implemented method according to claim 19, wherein:
each optically machine-readable identifier is assigned a specific UUID on a server and validated;
the verification program establishes contact with the server in order to compare for a match and checks whether a specific UUID exists for the optically machine-readable identifier; and
each time a data packet is read, the data is first verified via APIs by calculating a crypto hash and comparing it with a stored hash of a packet in an assigned blockchain.
